(19) United States
(12) Patent Application Publication
(10) Pub. No.: US 2025/0196776 A1
(43) Pub. Date: Jun. 19, 2025

(54) STRUCTURAL FLEXIBLE PANEL AND MOVABLE PARCEL SHELF USING THE STRUCTURAL FLEXIBLE PANEL

(71) Applicant: INTEVA PRODUCTS, LLC, Troy, MI (US)

(72) Inventor: Brian Staser, Oxford, MI (US)

(21) Appl. No.: 18/985,674

(22) Filed: Dec. 18, 2024

Related U.S. Application Data
(60) Provisional application No. 63/611,525, filed on Dec. 18, 2023.

(51) Int. Cl. B60R 5/04; E05F 15/00

(52) U.S. Cl. CPC B60R 5/044; E05F 15/00; E05Y 2900/53

(57) ABSTRACT

A moveable panel system of a vehicle, including: a tambor door secured to a rear portion of a rear seat of the vehicle, the tambor door comprising a flexible structural panel having a plurality of living hinges located between a plurality of structural regions of the flexible structural panel.

### CROSS REFERENCE TO RELATED APPLICATIONS

This application claims the benefit of U.S. Provisional Patent Application No. 63/611,525 filed on Dec. 18, 2023, the contents of which are incorporated herein by reference thereto.

### BACKGROUND

Exemplary embodiments of the present disclosure pertain to the art of structural panels and cargo covers for use in vehicles having a structural panel.

Sometimes it is desired to have a flexible panel that is structural. Typically, the structure is provided along one axis and the part can flex in an orthogonal axis. As such, it is desirable to provide a flexible panel that has a high strength to weight ratio material with low cost processing.

Power cargo covers employ a motor that drives a cover between a closed position and an open position.

Accordingly, it is desirable to provide improvements to the flexible panel that provides a cover for use with a system that opens and closes the cover.

### BRIEF DESCRIPTION

Disclosed is a flexible structural panel, including: a prefabbed polypropylene (PP) or thermoplastic honeycomb panel; glass fiber or natural fiber composite skins secured to opposite sides of the prefabbed polypropylene (PP) or thermoplastic honeycomb panel; and a plurality of living hinges located between structural regions of the flexible structural panel.

Also disclosed is a moveable panel system of a vehicle, including: a tambor door secured to a rear portion of a rear seat of the vehicle, the tambor door comprising a flexible structural panel having a plurality of living hinges located between a plurality of structural regions of the flexible structural panel.

In addition to one or more of the features described above, or as an alternative to any of the foregoing embodiments, the rear seat is a movable rear seat.

In addition to one or more of the features described above, or as an alternative to any of the foregoing embodiments, the tambor door is received in a storage chamber secured to a rear portion of the rear seat.

In addition to one or more of the features described above, or as an alternative to any of the foregoing embodiments, the storage chamber is pivotally secured to the rear portion of the rear seat.

In addition to one or more of the features described above, or as an alternative to any of the foregoing embodiments, the storage chamber is capable of movement between a first position when it is secured to the rear portion of the rear seat and a second position when it is received within a storage cavity located proximate to the rear seat.

In addition to one or more of the features described above, or as an alternative to any of the foregoing embodiments, the tambor door is operably coupled to a power mechanism in order to move the tambor door into and out of the storage chamber.

In addition to one or more of the features described above, or as an alternative to any of the foregoing embodiments, the tambor door is operably coupled to a power mechanism in order to move the tambor door.

In addition to one or more of the features described above, or as an alternative to any of the foregoing embodiments, the tambor door extends along a full width of the rear seat.

Also disclosed is a method of making a flexible structural panel, including: providing a prefabbed polypropylene (PP) or thermoplastic honeycomb panel with glass fiber or natural fiber composite skins to opposite sides of the prefabbed polypropylene (PP) or thermoplastic honeycomb panel; and moving the glass fiber or natural fiber composite skins towards each other in discrete separate areas to define living hinge portions via a thermo forming process.

In addition to one or more of the features described above, or as an alternative to any of the foregoing embodiments, the living hinges are separated by structural regions, the structural regions being formed by not moving the glass fiber or natural fiber composite skins towards each other.

Also disclosed is a method of making a flexible structural panel, including: providing a panel with glass fiber or natural fiber composite skins located on opposite sides of the panel; and moving the glass fiber or natural fiber composite skins away from each other in discrete separate areas to define structural regions of the flexible structural panel via a forming process.

In addition to one or more of the features described above, or as an alternative to any of the foregoing embodiments, further including living hinges that are separated by the structural regions, the living hinges being formed by not moving the glass fiber or natural fiber composite skins away from each other.

### BRIEF DESCRIPTION OF THE DRAWINGS

The following descriptions should not be considered limiting in any way. With reference to the accompanying drawings, like elements are numbered alike:

FIG. 1 is a cross-sectional view of a prefabbed polypropylene (PP) or thermoplastic honeycomb panel prior to forming in accordance with the present disclosure;

FIG. 2 is a perspective view of a flexible structural panel in accordance with an embodiment of the present disclosure;

FIG. 3 is a view along lines 3-3 of FIG. 2;

FIGS. 4A and 4B are cross-sectional views of a flexible structural panel being formed in accordance with an alternative embodiment of the present disclosure;

FIG. 5 is a schematic illustration of a moveable shelf in a vehicle compartment having a flexible structural panel in accordance with an embodiment of the present disclosure; and

FIG. 6 is a schematic illustration of a moveable shelf in a vehicle compartment having a flexible structural panel in accordance with another embodiment of the present disclosure.

### DETAILED DESCRIPTION

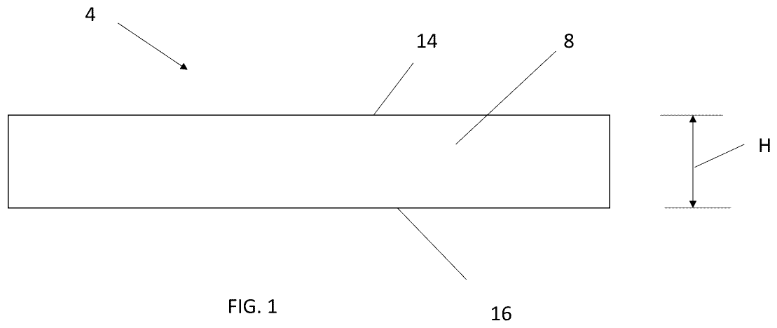

Referring now to FIG. 1 a cross-sectional view of a prefabbed polypropylene (PP) or thermoplastic honeycomb panel 4 prior to forming in accordance with the present disclosure is illustrated. The panel 4 is a prefabbed polypropylene (PP) or thermoplastic honeycomb panel 4 having an interior 8 with thin glass fiber or natural fiber composite outer skins 14 and 16. The outer skins 14 and 16 may be added to the interior 8 during the forming of the panel 4 or in separate step (e.g., applied to the interior 8 after it has been formed).

The prefabbed polypropylene (PP) or thermoplastic honeycomb panel 4 is light weight and the interior 8 is sandwiched between the fiber reinforced outer skins 14 and 16. The thin glass fiber or natural fiber composite outer skins 14 and 16 may be the same material or may be different from each other (e.g., skin 14 is different from skin 16). In addition, the skins 14, 16 will in one embodiment wrap around all exterior sides of the interior 8 until they meet or over lap with each other or they may be located on some but not all exterior surfaces of the interior 8 (e.g., they may not cover certain opposite sides of the interior 8 of the panel 4 while covering other opposite sides of the interior 8 of the panel 4) in order to provide the desired flexibility of a flexible structural panel 10 to be formed in accordance with the present disclosure. The prefabbed polypropylene (PP) or thermoplastic honeycomb panel 4 thickness will be selected as required for the structural requirements of the flexible structural panel 10 to be formed in accordance with the present disclosure.

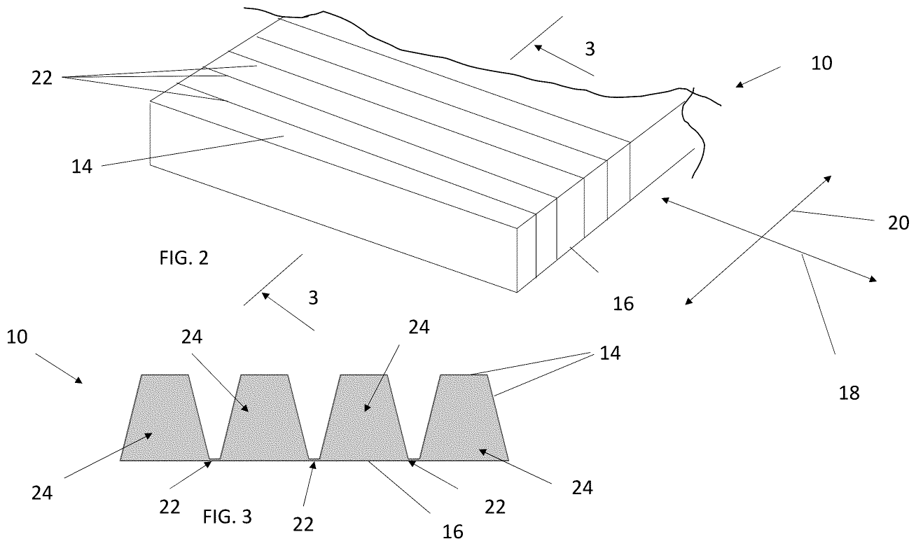

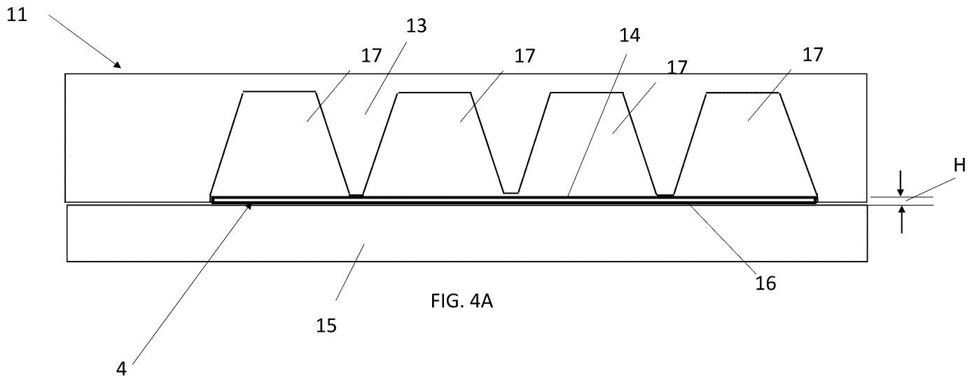

Referring now to FIG. 2, a perspective view of a portion of a flexible structural panel 10 in accordance with an embodiment of the present disclosure is illustrated. FIG. 3 is a cross sectional view of the flexible structural panel 10 along lines 3-3 of FIG. 2.

The flexible structural panel 10 is formed from the prefabbed polypropylene (PP) or thermoplastic honeycomb panel 4 with the aforementioned thin glass fiber or natural fiber composite skins 14 and 16. As mentioned above, the prefabbed polypropylene (PP) or thermoplastic honeycomb panel 4 is light weight and is sandwiched between the fiber reinforced skins 14 and 16. The prefabbed polypropylene (PP) or thermoplastic honeycomb panel 4 thickness would be selected as required for the structural requirements of the panel 10.

During a forming process, the panel 4 is then thermo-formed in a single step by securing the composite skins 14 and 16 on opposite sides of the panel 4 to each other in certain areas in order to create a very thin structure wherein the skins 14 and 16 would react as living hinges, thus allowing the panel to be rigid in one axis (e.g., along arrows 18) and flexible in another axis (e.g., along arrows 20) with an optimized strength to weight ratio. Of course, other axes are contemplated other than those specifically shown in FIG. 1.

In other words, the lightweight prefabbed polypropylene honeycomb is sandwiched between the fiber reinforced skins 14 and 16 in some areas and the skins 14 and 16 are drawn closer to and in some areas secured to each other during a thermoforming step to create flexible regions 22 between structural regions 24. In other words, the structural regions may comprise the fiber reinforced skins 14 and 16 spaced from each other or in other words unmodified sections of panel 4 while the flexible regions 22 are ultimately formed as the skins 14, 16 are moved closer to each other as illustrated in at least FIG. 3.

In an alternative embodiment, the skin 14 and/or 16 may comprise a polyester mat and the interior 8 is a foam core that is located in between the skins 14 and 16.

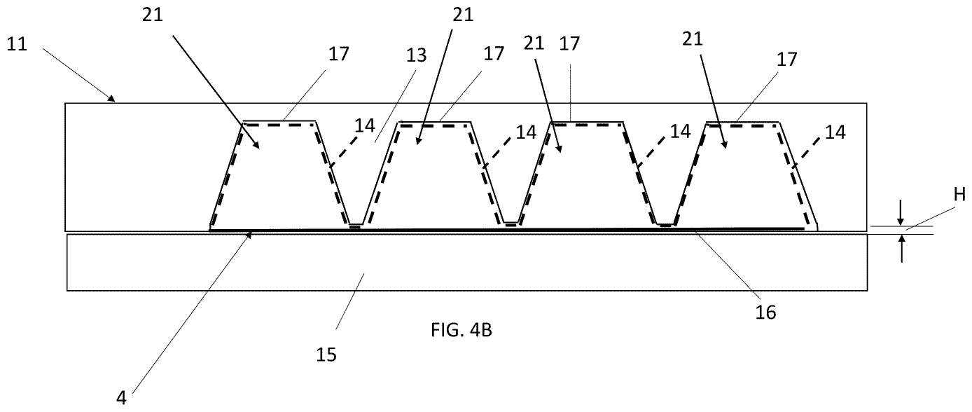

In another alternative embodiment and referring now to FIGS. 4A and 4B, the flexible structural panel 10 may be formed by starting with panel 4 of a given height “H” and instead of moving the fiber reinforced skins 14 and 16 towards each other to create the aforementioned flexible regions 22 between structural regions 24, the fiber reinforced skins or outer skins 14 and 16 start initially adjacent to each other and are moved away from each other. For example and by locating the panel 4 in a mold or tool 11 having an upper mold half 13 and a lower mold half 15 wherein the upper mold half 13 or alternatively the lower mold half 15 defines cavities 17 into which the outer skin 14 or outer skin 16 of the panel 4 may expand into while other areas of the panel 4 not aligning with cavities 17 do not expand. As such, the areas of non-expansion will define the flexible regions 22 while the cavities 17 and areas of expansion will define the structural regions 24. In other words, the height “H” of the unmodified panel 4 will define the height or thickness of the flexible regions 22 and the height of the structural regions 24 will be greater than the original height “H” of the panel 4. This would be in contrast to the thermoforming embodiment wherein the height “H” of the unmodified panel 4 will define the height or thickness of the structural regions 24 and the height of the flexible regions will be defined by reducing the height of the panel 4 in discrete areas. It being, of course, understood that the height “H” may vary depending on the desired forming process.

As mentioned above and is embodiment, the fiber reinforced skins or outer skins 14 and 16 may comprise thin glass fiber or natural fiber and the composite outer skins 14 and 16 may be the same material or may be different from each other (e.g., skin 14 is different from skin 16).

FIG. 4A illustrates the panel 4 in an unexpanded state while FIG. 4B illustrates the panel 4 in an expanded state where movement of the fiber reinforced skin 14 away from the fiber reinforced skin 16 is illustrated by the dashed lines. In other words, fiber reinforced skin 14 after it has been moved away from fiber reinforced skin 16 is illustrated by the dashed lines in FIG. 4B. This movement will create cavities 21 between fiber reinforced skin 14 and fiber reinforced skin 16. Although FIGS. 4A and 4B illustrate fiber reinforced skin 14 being moved away from fiber reinforced skin 16 it is, of course, understood that in an alternative embodiment fiber reinforced skin 16 can be moved away from fiber reinforced skin 14. In yet another alternative, both the fiber reinforced skin 14 and fiber reinforced skin 16 can be moved away from each other.

In one non limiting embodiment, and in order to cause the desired expansion of the outer skin or fiber reinforced skin 14 away from outer skin or fiber reinforced 16 in the tool or mold 11 of the embodiment of FIGS. 4A and 4B, a source of pressurized gas is provided between fiber reinforced skin 14 and fiber reinforced skin 16 when the panel 4 is located within the mold 11 and this pressurized gas will cause the outer skin 14 to separate from outer skin 16 in localized areas (defined by cavities 17) in order to provide the desired flexible regions 22 and structural regions 24 of the flexible structural panel 10. In an alternative embodiment, the pressurized gas may be replaced with a foam or expandable foam or combinations thereof (e.g., pressurized gas and a foam or expandable foam).

Notwithstanding the above, the flexible structural panel 10 may be formed from any other suitable process and/or materials where the flexible structural panel 10 has a plurality of living hinges located between a plurality of structural regions of the flexible structural panel 10. In other words, the flexible structural panel 10 need not be made by the above materials and/or processes as long as the flexible structural panel 10 has a plurality of living hinges located between a plurality of structural regions of the flexible structural panel 10.

As will be described herein and in at least one embodiment of the present disclosure the flexible structural panel 10 may be used as a powered cargo cover in a vehicle.

For example, sometimes it is desired to access a trunk area of the vehicle from within the passenger compartment. This has usually been done by either a folding seat arrangement or a folding armrest that reveals pass through access. If people are sitting in the seats then this becomes awkward. As such, it is desirable to provide access to the rear area of the vehicle through a parcel shelf behind the seat.

In accordance with the present disclosure one approach to gaining access to a trunk of the vehicle is through a movable parcel shelf located behind the seat of the vehicle.

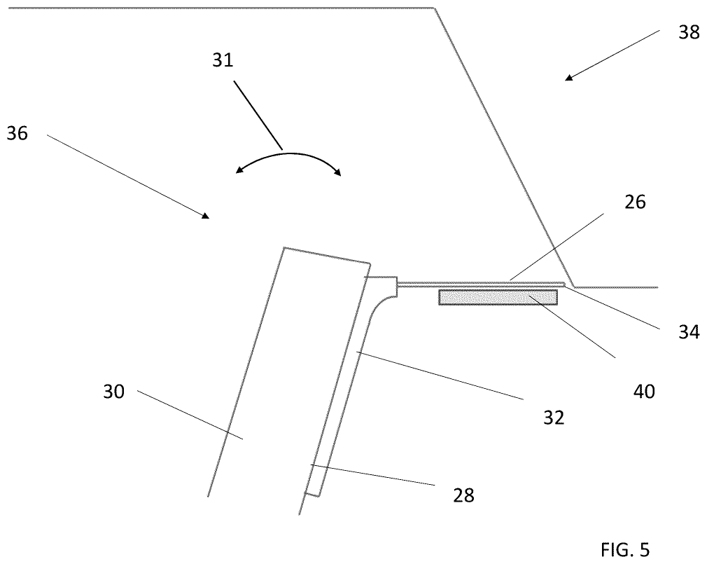

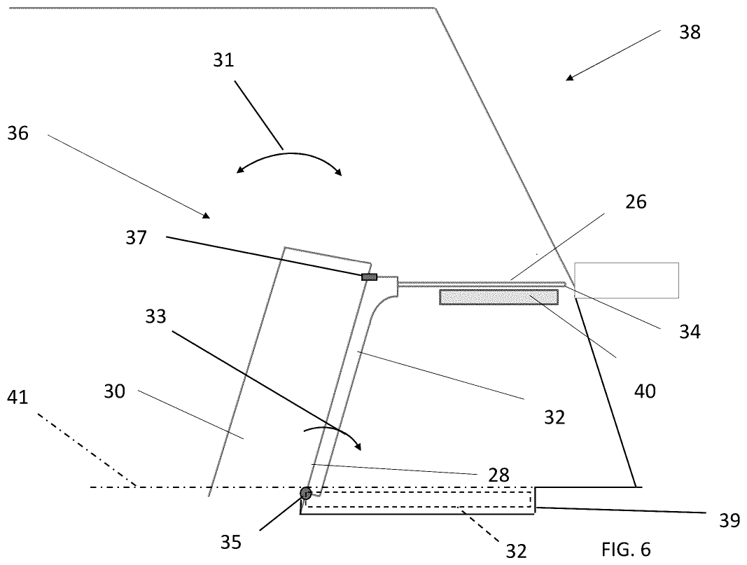

Referring now to FIG. 5, the flexible structural panel 10 functions as a tambor door or shelf 26 of a movable panel system 27 of the vehicle. Note: in the embodiments illustrated in FIGS. 5 and 6, the flexible structural panel 10 is not required to be made in accordance with the above embodiments. The flexible structural panel 10 as contemplated for use in FIGS. 5 and 6 need only to have a plurality of living hinges located between a plurality of structural regions of the flexible structural panel 10. In other words, the flexible structural panel 10 need not be made by the above materials and/or processes as long as the flexible structural panel 10 has a plurality of living hinges located between a plurality of structural regions of the flexible structural panel 10. The tambor door or shelf 26 of the moveable panel system 27 is secured to a rear portion 28 of a rear seat 30, which in one embodiment may be a movable rear seat 30 that can move in the directions of arrows 31. The tambor door or shelf 26 is received in a storage chamber 32 secured to the rear portion 28 of the rear seat 30 which allows the tambor door or shelf 26 to be opened by moving a rear edge 34 of the tambor door or shelf 26 forward. The rear edge 34 can be powered to move a distance from the rear closed position to a forward open position that correlates with the rear most position of the rear seat 30. This concept allows the rear seat 30 to have for/aft and tilt adjustment and still provide a complete parcel shelf when in the closed position since the shelf self adjusts as the seat 30 moves. In other words, the shelf 26 adjusts as the area to be covered by the shelf 26 changes due to the movement of the seat 30.

FIG. 5 illustrates a rear portion 36 of a vehicle 38 with a power mechanism 40 operably coupled to the tambor door or shelf 26 in order to move the tambor door or shelf 26 into and out of a storage chamber 32. The tambor door or shelf 26 is mounted to the back 28 of the rear seat 30. In one non-limiting embodiment, the tambor door 26 is the full width of the seat 30 or just a portion thereof. The rear edge 34 can be controlled by the power mechanism 40 that can open the door or shelf 26 to the rearmost position of an adjustable rear seat 30. As the seat is adjusted the shelf 26 size automatically feeds out of the storage chamber 32 as required to continue to provide a complete parcel shelf 26.

Referring now to FIG. 6, the storage chamber 32 may be pivotally secured to the back 28 of the rear seat 30 such that the storage chamber 32 can pivot between a first position where the storage chamber 32 is secured to the back 28 of the rear seat 30 and a second position where the storage chamber 32 pivots away from the back 28 of the rear seat 30 in the direction of arrow 33. The movement of storage chamber 32 in the direction of arrow 33 is possible due to the storage chamber 32 being pivotally mounted to the back 28 of the rear seat 30 via hinge or pivot 35. A catch or latch 37 is also provided to secure the storage chamber 32 to the back 28 of the rear seat 30 when it is in the first position.

When the storage chamber 32 is moved into the second position illustrated by the dashed lines in FIG. 6 it is received within a cavity 39 located in a rear area of the vehicle 38. At the same time, the rear seat 30 can pivot in a direction opposite to arrow 33 thus, the storage chamber 32 and the rear seat 30 can be orientated such that they provide a flat bottom surface of a storage area defined by line 41.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A flexible structural panel, comprising:
a prefabbed polypropylene (PP) or thermoplastic honeycomb panel;
glass fiber or natural fiber composite skins secured to opposite sides of the prefabbed polypropylene (PP) or thermoplastic honeycomb panel; and
a plurality of living hinges located between structural regions of the flexible structural panel.

2. A moveable panel system of a vehicle, comprising:
a tambor door secured to a rear portion of a rear seat of the vehicle, the tambor door comprising a flexible structural panel having a plurality of living hinges located between a plurality of structural regions of the flexible structural panel.

3. The moveable panel system of claim 2, wherein the rear seat is a movable rear seat.

4. The moveable panel system of claim 2, wherein the tambor door is received in a storage chamber secured to a rear portion of the rear seat.

5. The moveable panel system of claim 4, wherein the storage chamber is pivotally secured to the rear portion of the rear seat.

6. The moveable panel system of claim 5, wherein the storage chamber is capable of movement between a first position when it is secured to the rear portion of the rear seat and a second position when it is received within a storage cavity located proximate to the rear seat.

7. The moveable panel system of claim 4, wherein the tambor door is operably coupled to a power mechanism in order to move the tambor door into and out of the storage chamber.

8. The moveable panel system of claim 2, wherein the tambor door is operably coupled to a power mechanism in order to move the tambor door.

9. The moveable panel system of claim 2, wherein the tambor door extends along a full width of the rear seat.

10. A method of making a flexible structural panel, comprising:
providing a prefabbed polypropylene (PP) or thermoplastic honeycomb panel with glass fiber or natural fiber composite skins to opposite sides of the prefabbed polypropylene (PP) or thermoplastic honeycomb panel; and
moving the glass fiber or natural fiber composite skins towards each other in discrete separate areas to define living hinge portions via a thermo forming process.

11. The flexible structural panel as in claim 10, wherein the living hinge portions are separated by structural regions, the structural regions being formed by not moving the glass fiber or natural fiber composite skins towards each other.

12. A method of making a flexible structural panel, comprising:
providing a panel with glass fiber or natural fiber composite skins located on opposite sides of the panel; and
moving the glass fiber or natural fiber composite skins away from each other in discrete separate areas to define structural regions of the flexible structural panel via a forming process.

13. The flexible structural panel as in claim 12, wherein living hinges are separated by the structural regions, the living hinges being formed by not moving the glass fiber or natural fiber composite skins away from each other.
